(19) United States
(12) Patent Application Publication
(10) Pub. No.: US 2023/0401111 A1
(43) Pub. Date: Dec. 14, 2023

(54) ORCHESTRATING DATACENTER WORKLOADS BASED ON ENERGY FORECASTS

(71) Applicant: Quantum Loophole, Inc., Austin, TX (US)

(72) Inventors: Scott Noteboom, Hilo, HI (US); Josh Snowhorn, Austin, TX (US); Richard Paul-Hus, Sebring, FL (US); Shane Canekeratne, Austin, TX (US)

(21) Appl. No.: 18/249,958

(22) PCT Filed: Sep. 22, 2021
(86) PCT No.: PCT/US21/51440

§ 371 Date: Apr. 20, 2023

Related U.S. Application Data
(60) Provisional application No. 63/082,075, filed on Sep. 23, 2020.

(51) Int. Cl. G06F 9/50

(52) U.S. Cl. CPC G06F 9/5094; G06F 9/505

(57) ABSTRACT

Various embodiments of the present technology relate to systems and methods for orchestrating workflows to operate multi-site datacenters based on energy and cloud-computing supply and demand. In an embodiment, a method of operating a datacenter orchestration engine is provided. The method comprises, on a per-tenant basis, obtaining, via one or more machine learning models, at least a real-time utilization of energy grids and an energy supply of the energy grids available for use by datacenters over a period of time; obtaining, via the one or more machine learning models, a cloud-computing demand projected for the datacenters during the period of time; generating a cloud-computing optimization plan based at least on the real-time utilization of the energy grids, the available energy supply, and the cloud-computing demand; and providing the cloud-computing optimization plan to one or more tenants in a multi-tenant environment.

### RELATED APPLICATIONS

This application claims priority to PCT Patent application No. PCT/US21/51440, filed Sep. 22, 2021, entitled “ORCHESTRATING DATACENTER WORKLOADS BASED ON ENERGY FORECASTS;” as well as U.S. provisional patent application No. 63/082,075, filed Sep. 23, 2020, entitled “ORCHESTRATING DATACENTER WORKLOADS BASED ON ENERGY FORECASTS,” both of which are incorporated herein by reference in their entirety for all purposes.

### TECHNICAL FIELD

Various embodiments of the present technology generally relate to interconnected multi-site datacenters and the operation thereof. More specifically, some embodiments relate to system, methods, and devices for multi-site datacenter connectivity and operational workflows.

### BACKGROUND

The rise in virtual computing has evolved how computing services are rendered, how applications and infrastructures are built, and how data traverses through the Internet. Cloud computing refers to using dynamic and scalable compute resources accessible via the Internet. Datacenter operators can provide available compute resources to perform services, large or small, to public, private, or hybrid cloud customers.

Cloud computing, however, remains an expensive endeavor requiring large amounts of land, cable, time, and more. While datacenter operators have the ability to evaluate a capacity to take on compute jobs and re-route compute jobs accordingly, at present, there are no readily applicable solutions that can account for real-time energy usage, available renewable and non-renewable energy sources, potential weather impacts to a compute schedule, and other demands on datacenters. Thus, what is needed is an orchestration engine capable of ingesting machine learning outputs to analyze energy, specifically renewable energy, and cloud supply and demand to create an optimization plan.

### OVERVIEW

Various embodiments herein relate to systems, methods, and computer-readable media for orchestrating interconnected datacenters and operational workflows. More specifically, some embodiments relate to orchestrating multi-site datacenters and associated workflows to operate the datacenters based on energy and cloud-computing supply and demand. Datacenters may be interconnected by fiber-optic cables that obtain power from non-renewable and renewable energy sources. An orchestration engine, like one disclosed herein, can obtain, via one or more machine learning models, energy consumption and cost data, climate data, internet utilization, and cloud computing data, determine cloud demand projections, determine energy supply projections, produce an energy storage and cloud-computing optimization plan, and communicate a supply and demand orchestration policy downstream.

In such embodiments, the energy storage optimization plan may use renewable and grid energy supplies to charge at least one or more batteries to be used during energy shortages, for example. The supply and demand orchestration policy may be used at one or more of the datacenters or by a third party via an integration. It may also be used to determine which energy source to use at which datacenter for one or more specific computing jobs.

In an embodiment, a method of operating a datacenter orchestration engine is provided. The method comprises obtaining, via one or more machine learning models, at least a real-time utilization of energy grids and an energy supply of the energy grids available for use by datacenters over a period of time. The method further comprises obtaining, via the one or more machine learning models, a cloud-computing demand projected for the datacenters during the period of time. The method also comprises orchestrating a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to perform cloud-computing jobs and providing the cloud-computing optimization plan to one or more applications.

In other embodiments, the two or more datacenters may be interconnected by miles of fiber-optic cables. The fiber-optic cables may comprise at least one hundred thousand strands of cable spliced together and connected by a coupling device. Said coupling device may comprise a sleeve and a locking mechanism to hold two ends of the fiber-optic cables together for protection. In various embodiments, the sleeve covers spliced ends of the fiber-optic cables, while the locking mechanism seals the sleeve from outside pollutants or intrusions. Each site or campus interconnection may be achieved by robotic cross-connect platforms that allow for simultaneous moves and adds for fiber-optic cross-connects within a five-minute window. A fiber optic distance window tolerance of one to sixty-five miles is maintained to reduce optical latency and allow the use of low-cost optics for telecommunications transmission. A point of presence (POP) in either a single or dual configuration allows for the 100,000 plus strand count fiber optic system to be terminated in an existing telecommunications market for the handoff of traffic from the two or more datacenters to other parties. Additionally, telecommunications providers may be able to connect at each data center to pass traffic to other markets and undersea cable systems for datacenter tenants.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the disclosure. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 illustrates an exemplary system architecture in which some embodiments of the present technology may be utilized;

FIG. 2 is a flowchart illustrating a series of steps of operating an orchestration engine in accordance with some embodiments of the present technology;

FIG. 3 illustrates an exemplary operational environment for orchestrating datacenter workflows in accordance with some embodiments of the present technology;

FIG. 4 illustrates an exemplary system architecture in which some embodiments of the present technology may be utilized;

FIGS. 5A and 5B illustrate cross-section views of a fiber-optic communication bundle in accordance with some embodiments of the present technology;

FIGS. 6A, 6B, 6C, 6D, 6E, and 6F illustrate a coupling apparatus and pull-plate apparatus for fiber-optic telecommunications bundles in accordance with some embodiments of the present technology;

FIGS. 7A, 7B, 7C, and 7D illustrate a series of steps to use a coupling apparatus with a fiber-optic communication bundle in accordance with some embodiments of the present technology;

FIG. 8 is a flowchart illustrating a mode of operations of an orchestration system in accordance with some embodiments of the present technology; and

FIG. 9 illustrates an example of a computing system in accordance with some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to systems, methods, and computer-readable media for orchestrating interconnected datacenters and operational workflows. Operational workflows and data loading can be used to balance computing jobs and workloads taken on by a datacenter. Based on energy consumption, scheduled jobs, and more, workloads may be shifted from one datacenter to another to ensure optimal performance and efficiency. Using datapoints captured via machine learning models including but not limited to climate data, internet utilization, cloud computing data and projections, energy rates and status, grid reliability, and similar factors, an operational supply and demand plan can provide for an energy efficient method of balancing datacenter workload.

In some embodiments, multiple datacenter sites or campuses may be located geographically and physically close to each other, wired together by over a hundred thousand strands of fiber-optic communication cables. Fiber interconnection at each campus head end may be achieved using robotic cross-connect platforms that may allow for simultaneous moves and adds for fiber cross-connects within a five-minute window. Such robotic cross-connect platforms may include a multiplexer or switching unit that may uncouple one bundle of fiber-optic cables or one strand of cable of a bundle to redirect data from one datacenter to another, for example. This may occur based on power or capacity limitations at one datacenter to allow data transfer to another to complete a job. A fiber-optic distance window tolerance of 1 to 65 miles is maintained to reduce optical latency and allow the use of low-cost optics for telecommunications transmission. Each campus may be fed by grid power paths or renewable energy sources that are unique to that campus to help prevent the failure of more than one campus from the same power line outage.

Some embodiments provide a unique operation and functionality of one or more datacenters. In accordance with the present disclosure, a datacenter orchestration policy engine may obtain data from reflective, predictive, and responsive machine learning models. Such data may be used to understand current information such as weather, energy usage, internet or network traffic, and energy cost. Additionally, past performance or scheduling may also impact the datacenter orchestration policy. Further, projections or predictions may be captured about energy usage, internet traffic, and more.

In an instance, a method of operating a datacenter orchestration engine in a multi-tenant environment is provided. The method comprises, on a per-tenant basis, obtaining, via one or more machine learning models, at least a real-time utilization of energy grids and an available energy supply of the energy grids for use by datacenters over a period of time; obtaining, via the one or more machine learning models, a cloud-computing demand projected for the datacenters during the period of time; generating a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to the datacenters; and providing the cloud-computing optimization plan to one or more tenants in the multi-tenant environment.

In another instance, a computing apparatus comprising one or more computer-readable storage media, a processing system operatively coupled with the one or more computer-readable storage media, and program instructions stored on the one or more computing-readable storage media that, based on being read and executed by the processing system, direct the computing apparatus to perform various functions. For example, the program instructions can direct the computing apparatus to, on a per-tenant basis, obtain, via one or more machine learning models, at least a real-time utilization of energy grids and an available energy supply of the energy grids for use by datacenters over a period of time. The computing apparatus can also be directed to obtain, via the one or more machine learning models, a cloud-computing demand projected for the datacenters during the period of time. Further, the computing apparatus can be directed to generate a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to the datacenters and provide the cloud-computing optimization plan to one or more tenants.

In yet another instance, one or more computer-readable storage media having program instructions stored thereon to operate a datacenter orchestration engine is provided. The program instructions, when read and executed by a processing system, direct the processing system to at least obtain, via one or more machine learning models, at least a real-time utilization of energy grids and an available energy supply of the energy grids for use by datacenters over a period of time and obtain, via the one or more machine learning models, a cloud-computing demand projected for the datacenters during the period of time. The program instructions can further direct the processing system to generate a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to the datacenters and provide the cloud-computing optimization plan to one or more tenants.

In a further instance, a fiber-optic bundle coupling apparatus is provided. The apparatus comprises a first coupling end, wherein the first coupling end encapsulates a first fiber-optic bundle of at least 100,000 fiber-optic cables inserted into a strand separator and surrounded by a first rubber sleeve. The apparatus also comprises a second coupling end, wherein the second coupling end encapsulates a second fiber-optic bundle of at least 100,000 fiber-optic cables surrounded by a second rubber sleeve. And the apparatus further comprises a locking mechanism, wherein the first fiber-optic bundle and the second fiber-optic bundle are spliced together and the first coupling end and the second coupling end are mated to cover spliced areas of the first and second fiber-optic bundles.

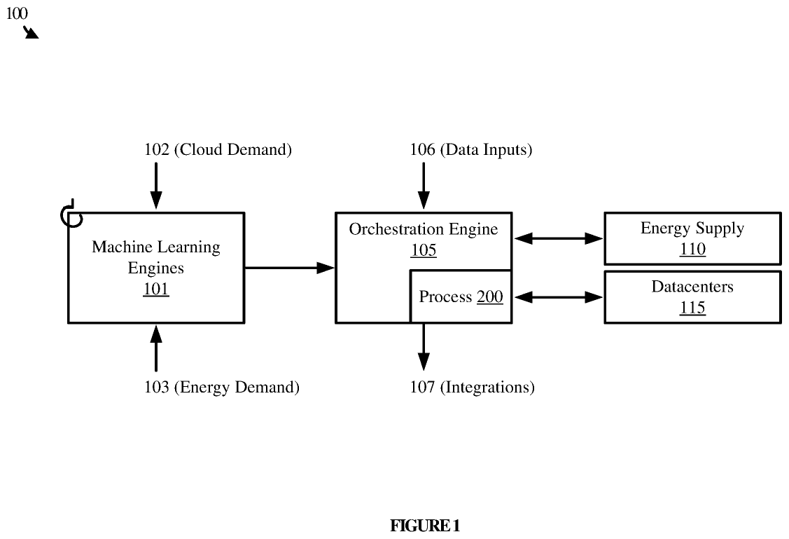

Turning now to the Figures, FIG. 1 illustrates an exemplary system architecture in which some embodiments of the present technology may be utilized. FIG. 1 includes architecture 100 which further includes machine learning engines 101, orchestration engine 105, energy supply 110, and data centers 115. Machine learning engines 101 intake cloud demand 102 and energy demand 103 and pass data to orchestration engine 105. Orchestration engine 105 also ingests data inputs 106 and executes process 200 to create a datacenter orchestration plan that can be passed to energy supply 110, datacenters 115, and integrations 107. It may be appreciated that architecture 100 can be applied in multi-tenant or single-tenant datacenter environments.

In operation, machine learning engines 101 comprise machine learning models, such as reflective, responsive, and predictive models, configured to analyze historical and current data regarding cloud-computing jobs and internet utilization, weather, news, energy consumption and reliability, and more. Machine learning engines 101 obtain such information via cloud demand 102 and energy demand 103, among other databases or repositories. Cloud demand 102 can provide information on a datacenter's workload, capacity, previous and current scheduling, and the like. More specifically, cloud demand 102 can indicate each tenant of the datacenter and the tenant's workload, capacity, priority, and more. Accordingly, machine learning engines 101 can identify issues or availability of the datacenter, and further, they can predict future availability or upticks in demand. Similarly, energy demand 103 provides information on energy grids available for use by the datacenter. These could include renewable and non-renewable energy sources. Energy demand 103 may indicate how much energy is being used currently, previous energy usage history, available energy supplies, and the like.

Machine learning engines 101 can also connect with other sources to determine impacts to cloud demand 102 and energy demand 103. For example, machine learning engines 101 can identify inclement weather in areas, which may lead to power outages or an increase in energy usage. In another example, machine learning engines 101 can predict an increase in cloud-computing jobs due to foreseeable online shopping or other Internet traffic increases.

Machine learning engines 101 can communicate, via a number of wireless or wired communication links, the reflective, responsive, and predictive outputs to orchestration engine 105. Orchestration engine 105 may be one or more orchestration layers configured to execute on software, hardware, or any combination thereof. As such, orchestration engine 105 can include layers to project cloud demand, energy supply, energy storage optimization, and other real-time microservices. In addition to outputs from machine learning engines 101, orchestration engine 105 can also receive data inputs 106 comprising information related to an application requesting a datacenter workflow policy, user inputs, graphical user interface inputs, and the like. In an instance, user inputs can influence the orchestration policy to be created by orchestration engine 105. For example, a user can make selections of energy sources or datacenter locations to use to complete compute jobs. Orchestration engine 105, using each input, can then generate a datacenter orchestration policy that governs datacenter workflows and scheduling of compute jobs based on the supply and demand of cloud-computing resources and energy, among other things.

In various embodiments, the datacenter orchestration policy can dictate where each cloud-computing job is performed (i.e., between datacenters or within a single datacenter), by which equipment in a datacenter, and at what times. The datacenter orchestration policy can also determine which energy supply 110 to use for certain jobs. This policy can provide various benefits, such as efficient use of processing power available at datacenter(s), reduced processing time, optimal and cost-effective energy usage, environmental protection via renewable energy usage, and more. Orchestration engine 105 can then communicate the datacenter orchestration policy downstream to each of integrations 107, energy supply 110, and datacenters 115. It may be appreciated that the datacenter orchestration policy can be stored locally or in a cloud environment and communicated elsewhere via communication links, such as application programming interfaces. For example, the policy can be communicated to third party applications or other cloud integrations via integrations 107.

Energy supply 110 can refer to an energy storage mechanism, a utility substation, or any combination thereof. The datacenter orchestration policy can indicate which energy source to use, the timing of energy usage, and/or whether to store energy by some mechanism (i.e., batteries) for future use. Energy supply 110 can include any type of energy supply including both renewable and non-renewable energy sources. In various embodiments, the datacenter orchestration policy can recommend renewable energy sources in place of non-renewable energy sources to conserve natural resources, reduce costs, and/or use green energy, among other reasons.

Datacenters 115 can include multi-site, interconnected datacenters, distributed datacenters, or a single datacenter configured to intake cloud-computing jobs from one or more datacenter tenants, process the jobs, and output results to an end-user/tenant. The datacenter orchestration policy provided by orchestration engine 105 can indicate a potential routing and schedule of jobs to be performed at datacenters 115. In some instances, an end-user or tenant may update, accept, or reject the datacenter orchestration policy. It may be appreciated that energy supply 110 can feed power to datacenters 115 in order to function according to the datacenter orchestration policy.

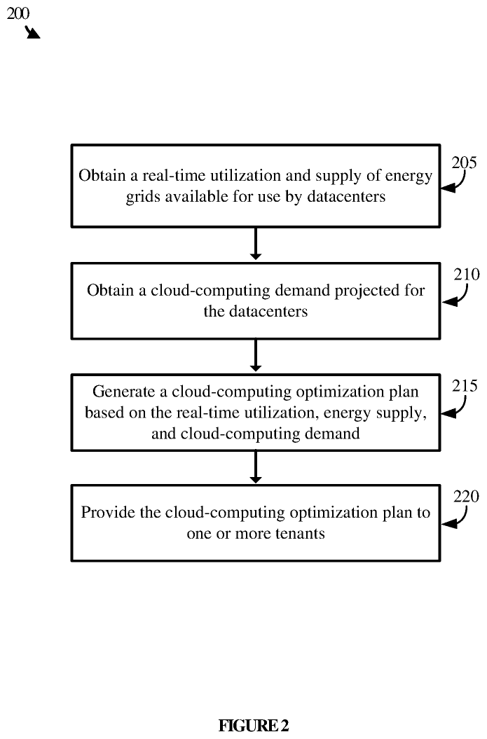

FIG. 2 is a flowchart illustrating a series of steps of operating an orchestration engine in accordance with some embodiments of the present technology. FIG. 2 includes process 200, each operation noted parenthetically in the discussion below and which reference elements of FIG. 1. It may be appreciated that process 200 can be implemented on software, hardware, or any combination thereof. For example, process 200 can be executed on or by orchestration engine 105 of FIG. 1.

In operation 205, machine learning engines 101 obtain (205) at least a real-time utilization of energy grids and an available energy supply of the energy grids (i.e., energy demand 103) for use by datacenters over a period of time. The energy grids can be renewable and/or non-renewable energy sources that provide metrics on current usage, historical usage, and/or projected usage for a timeframe. The energy grids can also indicate a percentage of usage distributed for various uses. Of the uses, the energy grids may indicate how much energy can be used by one or more datacenters.

Next, in operation 210, machine learning engines 101 obtain (210) a cloud-computing demand (i.e., cloud demand 102) projected for the datacenters during the period of time. Machine learning engines 101 can use reflective, responsive, and/or predictive machine learning models to analyze historical resource demand, current demand, and projected demand for a timeframe. In instances where the machine learning engines 101 determine that, historically, high demand occurs at a certain time of day/month/year, the machine learning engines 101 can compare the current demand and project whether it will increase or decrease and require additional or fewer resources, respectively.

In operation 215, orchestration engine 105 generates (215) a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to perform cloud-computing jobs. Accordingly, an orchestration plan generated by orchestration engine 105 can at least route and/or re-route cloud-computing jobs to different datacenters (or different parts of a datacenter) and use and/or switch between energy sources during the time that the cloud-computing jobs are being performed.

For example, orchestration engine 105 may determine that electricity has a high-cost during the time that resources are required to perform compute jobs, while wind-turbine energy has an abundance of energy available that the datacenter can use. Use of renewable energy supplies can lead to cost-savings and/or environmental savings, among other benefits. As such, orchestration engine 105 or a tenant of a datacenter can choose to use power from the latter to perform the jobs more cost-effectively. In another example, the datacenters may be overloaded with cloud-computing jobs during a night, yet the machine learning engines 101 determine that capacity will become available during certain stretches of the night and following morning. Accordingly, orchestration engine 105 can generate a schedule and routing plan for certain jobs to be performed during different stretches where the jobs can be performed effectively and efficiently. In such examples, orchestration engine 105 can consider various aspects of the cloud-computing jobs, such as required processing power, job duration, priority, customer/client, and the like to schedule the jobs appropriately. More specifically, if a lengthy compute job requires significant processing capacity and time to complete, orchestration engine 105 can schedule the job according to either the cloud demand projection or the energy grid availability and cost, or some combination thereof.

Lastly, in operation 220, orchestration engine 105 provides (220) the cloud-computing optimization plan to one or more tenants. Orchestration engine 105 can communicate with third party applications via communication links, such as application programming interfaces. The applications can comprise integrations for datacenter operators, customers or tenants of the datacenter(s), utilities operators, and more to interact with the cloud-computing optimization plan and aspects of the process described herein.

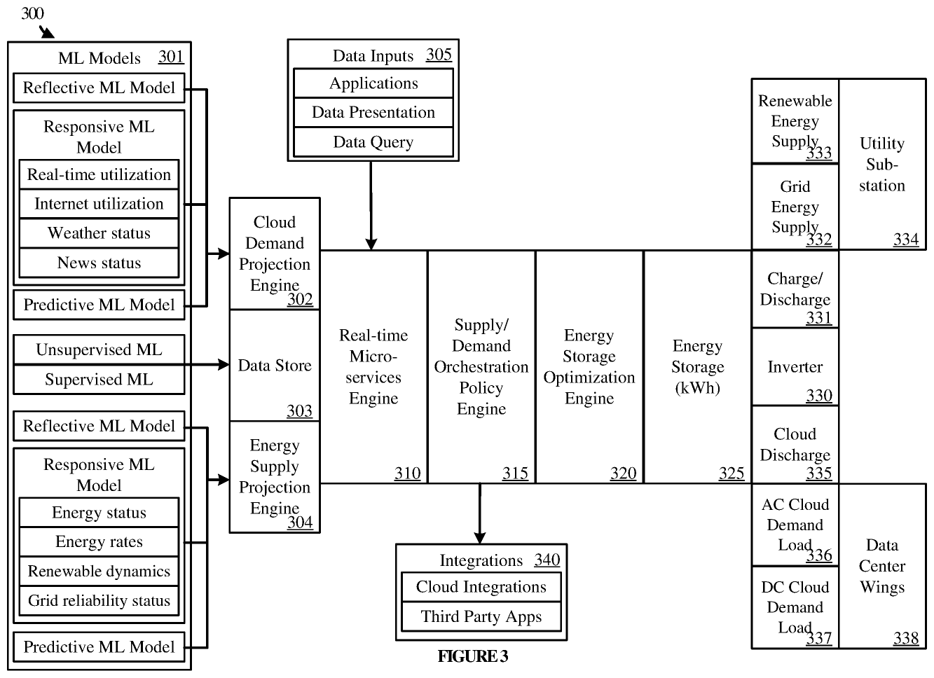

Moving to FIG. 3, FIG. 3 illustrates an exemplary operational architecture for orchestrating datacenter workflows in accordance with some embodiments of the present technology. FIG. 3 includes architectural environment 300 which further includes machine learning (ML) models 301, cloud demand projection engine 302, data store 303, energy supply projection engine 304, data inputs 305, real-time microservices engine 310, supply and demand orchestration policy engine 315, energy storage optimization engine 320, energy storage 325, inverter 330, energy charge/discharge apparatus 331, grid energy supply 332, renewable energy supply 333, utility substation 334, cloud demand discharge 335, AC cloud demand load 336, DC cloud demand load 337, datacenter wings 338, and integrations 340. Architectural environment 300 serves to optimize cloud demand, energy supplies, and energy storage by factoring in various energy loads, computing traffic, and supply and demand of each, among other things while employing a cross-section of hardware, software, firmware, and the like as one example of an operating architectural environment that may be used at one or more datacenter sites, such as illustrated in FIG. 1.

ML models 301 comprise at least a reflective ML model, predictive ML model, responsive ML model, supervised ML model, and unsupervised ML model. In some embodiments reflective, predictive, and responsive ML models are input to cloud demand projection engine 302. Likewise, each of the aforementioned ML models may also be input into energy supply projection engine 304. Data store 303 may use both supervised and unsupervised ML models as data input. Responsive ML models may include data points on real-time cloud utilization, internet traffic and utilization, weather status, news status, energy status, energy rates, renewable energy dynamics and usage, and grid reliability status, among other things. Predictive ML models may include projected information regarding cloud computing and energy demand, usage, and status. Likewise, reflective ML models may use similar data or types of data to orchestrate plans that learn from previous jobs or events.

Using ML models as inputs, cloud demand engine 302, data store 303, and energy supply projection engine 304 may compile the information collected by the one or more ML models to project cloud computing demand, store additional data, and project energy supplies, respectively. Data store 303 may function as a repository for additional data, and it may be accessed locally, remotely, or over a cloud integration, in some embodiments. Next, real-time microservices engine 310 may use data from cloud demand projection engine 302 and energy supply projection engine 304 along with data inputs 305 to gauge current usage and system needs. Data inputs 305 may include applications, data presentation, and data query.

Energy storage optimization engine 320 utilizes energy storage 325, inverter 330, energy charge/discharge apparatus 331, grid energy supply 332, renewable energy supply 333, utility substation 334, cloud demand discharge 335, AC cloud demand load 336, DC demand load 337, and datacenter wings 338 to build an optimal plan to run as part of the overall orchestration plan. In turn, energy storage 325 may operate based on energy storage optimization engine 320. Energy storage 325 may include one or more batteries, generators, and/or other energy storage apparatuses or mechanisms. Energy storage 325 may be fed by grid energy supply 332, renewable energy supply 333, and utility substation 334 that each use energy charge/discharge apparatus 331 and inverter 330 to convert existing energy into stored energy. Grid energy supply 332 may be an existing, local power path from an electrical grid, while renewable energy supply 333 may be one of many types of renewable energy sources. Meanwhile, energy storage 325 may also be fed by AC cloud demand load 336, DC cloud demand load 337, and datacenter wings 338 that each uses cloud demand discharge 335 and inverter 330 to convert energy into the correct form for storage. Based on a supply of energy and a stored amount of energy, energy storage optimization engine 320 may generate a plan to utilize some energy and conserve other energy based on cloud demand and energy supplies.

Upon generating energy storage optimization engine 320, supply and demand orchestration policy engine 315 may provide operational workflows for one or more datacenters based on input from the ML models 301, real-time microservices engine 310, and energy storage optimization engine 320. Supply and demand orchestration policy engine 315 may dictate commands to a system, computing apparatus, or the like to schedule computing jobs, reroute computing jobs, employ the use of specific energy sources over others, and the like to maintain energy and job efficiency in the datacenter. Supply and demand orchestration policy engine 315 may then communicate commands or a plan to integrations 340 that further includes cloud integrations and third-party applications. Communication to integrations 340 may be completed over a secure file transfer protocol, application programming interface, or any number of calls that need not be explained for the sake of brevity.

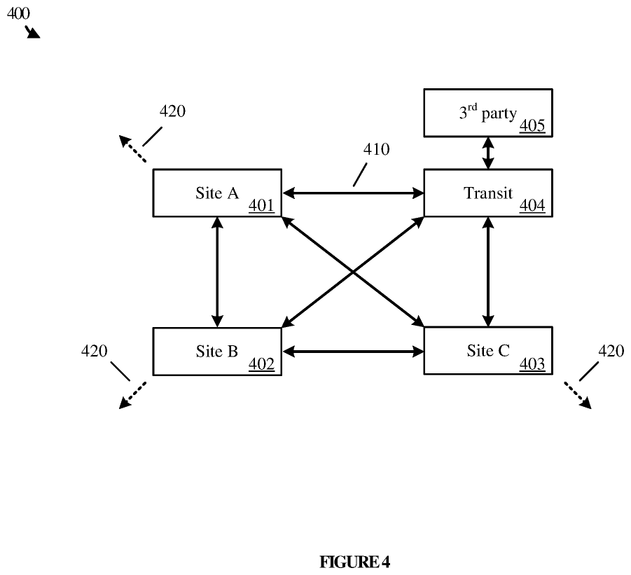

FIG. 4 illustrates an exemplary operational environment 400 in which some embodiments of the present technology may be utilized. FIG. 4 demonstrates operational environment 400 which further includes site A 401, site B 402, site C 403, transit 404, 3rd party 405, fiber-optic bundles 410, and telecommunications lines 420. Operational environment 400 may be comprised of a mix of hardware, software, firmware, vaporware, and the like. In the illustrated FIG. 4, interconnected multi-site datacenters use grid energy to operate while data-loading between each other by using fiber-optic cables that connect each site together. Each site may securely upload data to a cloud or other external network to communicate with other datacenters or third party applications.

In accordance with some embodiments, site A 401, site B 402, and site C 403 comprise datacenters capable of performing computing jobs. Each site may obtain power from a grid or renewable energy sources independently of one another. For example, site A 401 may connect to a local electric grid, site B 402 may be powered by solar cells, and site C 403 may be powered by wind turbines. Alternatively, each site of the three sites may utilize grid power but may use unique grid power paths as another way to prevent failure of more than one site from the same power line outage. The benefit of having independent sources of power helps mitigate power failures, so that one or more sites may continue operating during a power failure of one site's energy source. Transmission scale grid power may add uptime resiliency which may negate the need for traditional datacenter backup generators as well.

As illustrated in FIG. 4, each of site A 401, site B 402, and site C 403, along with transit 404 and 3rd party 405, may be interconnected by fiber-optic bundles 410. Fiber-optic bundles 410 comprise at least 100,000 strands of fiber-optic cables that may be spliced or coupled together. Each site may be interconnected by fiber-optic bundles 410 from one to 65 miles apart to help reduce latency and allow for low-cost optics for telecommunications transmissions. At an interconnection point at transit 404, a point of presence (POP) may exist in a single or dual configuration which allows fiber-optic bundles 410 to be terminated in an existing telecommunications market for a handoff of traffic from each datacenter site to other parties. Transit 404 may serve as an ingress/egress into and out of each site's network or a 3rd party 405 network and may operate as a cloud network.

At each site, fiber-optic bundles 410 may be interconnected at each campus or site using robotic cross-connect platforms to allow for simultaneous moves and adds for fiber-optic connections within a five-minute window. The robotic cross-connect platforms may comprise a multiplexer, switching unit, or the like that allows fiber-optic bundles 410 to connect one site to another site for data transfer or another telecommunications transmission. By way of example, site A 401 may have an increased demand for computing jobs, while site C 403 may be underutilized. A switching unit may then connect fiber-optic bundles 410 from site A 401 to connect to site C 403 to reroute data from one to the other, respectively. As another example, site A 401 may have high energy costs to perform a job, while site C 403 has lower energy costs to complete the same job. Thus, a job may be rerouted to save costs and time using switching unit or robotic cross-connect platforms.

From each site of the three sites, telecommunications lines 420 may allow the passage of traffic to other markets. Some telecommunications lines 420 may be undersea cable systems, depending on geographic location, to provide data to tenants of the datacenter campuses.

Moving to FIGS. 5A and 5B, both Figures illustrate a cross-section view of a fiber-optic communication bundle in accordance with some embodiments of the present technology. Fiber-optic bundles 410, as demonstrated in FIG. 4, may comprise at least 100,000 strands of fiber-optic cables. Inside a conduit housing the bundle, fiber-optic cables of varying diameter may be used to accomplish system objectives.

As demonstrated in FIG. 5A, for example, fiber-optic bundles 410 may use a fiber-optic strand 501 and a fiber-optic strand 502 in various patterns and sizes to maximize space. The pattern used may resemble for a 41-way pattern of fiber-optic cable bundling. Using various sizes of strands may allow for a minimally sized conduit to house the bundle to lessen the environmental impact when installing the conduit underground or undersea, for example.

Similarly, FIG. 5B demonstrates a cross-section view of fiber-optic bundles 110 that may use a single size fiber optic strand 503. In some embodiments, a 5.10 pattern may be used to accomplish such a pattern of fiber-optic cable bundling.

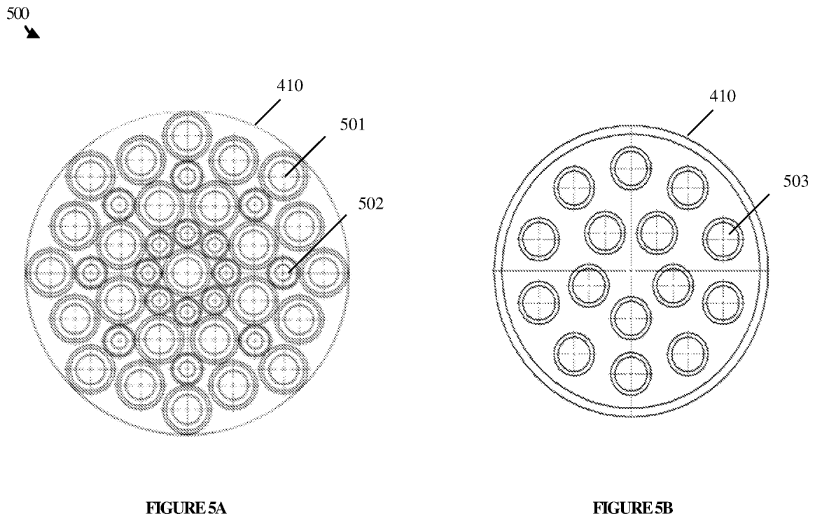

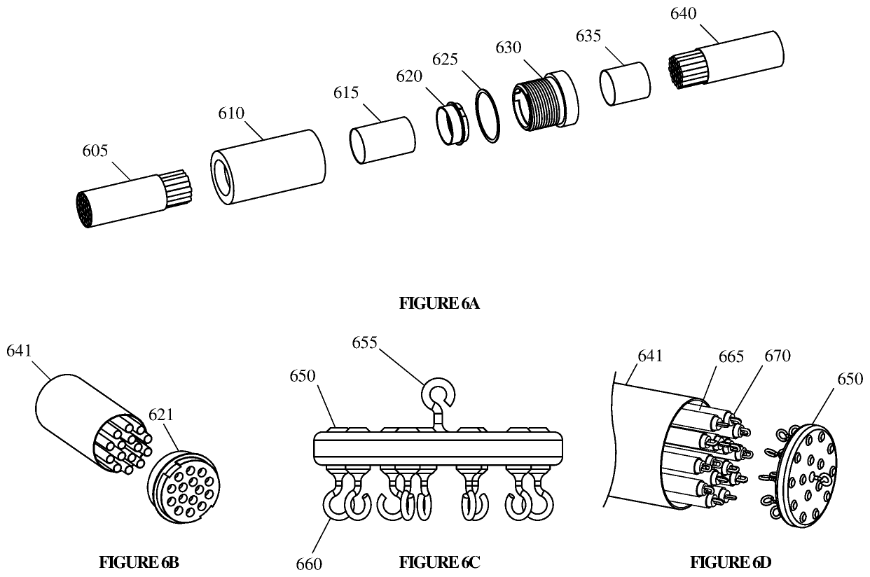

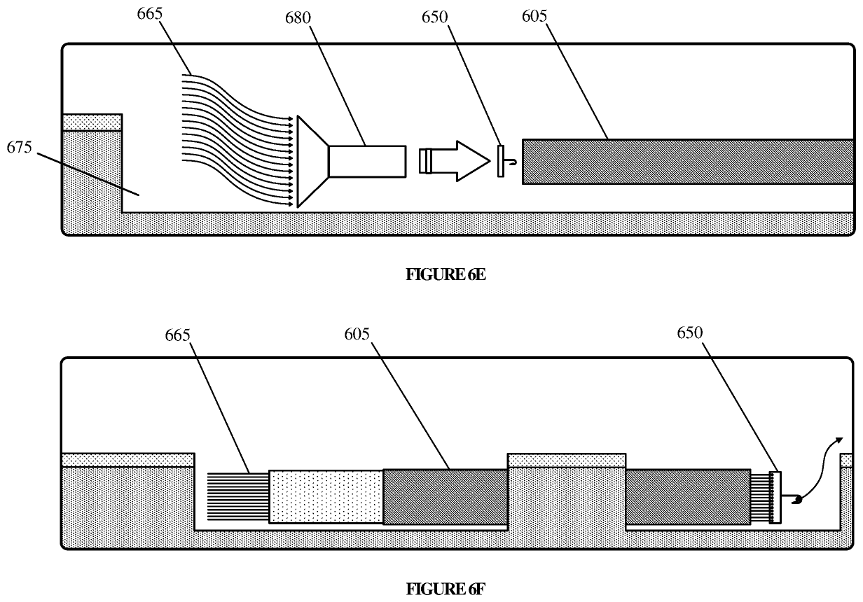

Next, FIGS. 6A, 6B, 6C, 6D, 6E, and 6F illustrate a coupling apparatus and pull-plate apparatus for fiber-optic telecommunications bundles in accordance with some embodiments of the present technology.

FIG. 6A includes conduit A 605, coupling end A 610, rubber sleeve A 615, 41-way hybrid insert 620, rubber O-ring 625, coupling end B 630, rubber sleeve B 635, and conduit B 640. The coupling apparatus or device exemplified in FIG. 6A may be employed to interconnect datacenter campuses and/or connect fiber-optic bundles together at various points, among other uses.

In various embodiments, conduit A 605 may comprise a fiber-optic cable bundle of 100,000 strands of cable, like fiber-optic bundles 110 as illustrated in FIG. 1. Rubber sleeve A 615 may be inserted into coupling end A 610, and subsequently, conduit A 605 may be inserted into coupling end A 610 thereafter. Meanwhile, rubber sleeve B 635 may be inserted into coupling end B 630, rubber O-ring 625 may be placed over the grooves of coupling end B 630, and 41-way hybrid insert 620 may be inserted on the other end of coupling end B 630. Then, conduit B 640 may be inserted into coupling end B 630. Both conduit A 605 and conduit B 640 each have part of the coupling apparatus covering part of their respective fiber-optic bundle end.

Finally, the ends of conduit A 605 and conduit B 640 may be spliced together using one more splicing methods. By way of example, given the large quantity of stands of fiber-optic cables in each bundle that may be spliced together, the conduits may be fusion spliced together by a machine. In other embodiments, the bundles may be spliced together using integrated robotics. In such examples, a large container may be used to house the spliced areas of bundles underground or above ground wherein robotics or other splicing machinery may be utilized to accomplish the splicing process.

Upon completion of the splicing process of conduit A 605 and conduit B 640, coupling end A 610 may be inserted, locked, screwed, twisted, mated, or the like into coupling end B 630 to ensure the coupling apparatus covers the spliced area of cables. Further, in some embodiments, an injectable resin or epoxy may be inserted into the coupling apparatus to ensure safety of the spliced cable bundles. Using such methods may also create air-tight, waterproof sections of spliced cables for protection from pollutants or water. Additionally, rubber O-ring 625 may provide additional safety from pollutants, air, or water.

FIG. 6B demonstrates a conduit C 641 and rubber sleeve C 621 that may be used in place of conduit A 605, conduit B 640, and rubber sleeve B 620. The other illustrated pieces of coupling apparatus may be used interchangeably. Conduit C 641 and rubber sleeve 621 embody a different fiber-optic cable bundle that may use a 5.10 cable pattern for varying uses.

FIG. 6C illustrates a view of a pull-plate apparatus that can be used to pull fiber-optic cables or conduits simultaneously. FIG. 6C includes pull plate 650, pull hook 655, and cable hook 660. Pull plate 650 is designed to include a number of cable hooks 660 equivalent to the number of fiber-optic cables that need to be pulled through a conduit, pipe, or the like. In some embodiments, a swivel head or other hooking mechanism is inserted into a conduit to be attached to cable hook 660. Pull plate 650 also includes one or more of pull hook 655 used to pull on the other side of pull plate 650 and withstand a large weight of cables. In order to perform the pulling of cables, pull hook 655 may be attached to a winch or other mechanical device.

FIG. 6D illustrates an isometric view of a pull-plate apparatus and a conduit of fiber-optic cables. FIG. 6D includes conduit C 641, duct 665, swivel head 670, and pull plate 650. As shown, conduit 641 includes a number of duct 665 each comprising fiber-optic cables to be used in accordance with the present disclosure. Swivel head 670 is placed in duct 665 to pull duct 665 through conduit C 641. When swivel head 670 is placed in duct 665, pull plate 650 may hook onto each of swivel head 670 so that the pulling of each duct 665 is completed simultaneously, at the same speed.

FIGS. 6E and 6F illustrate an exemplary sequence of pulling ducts of fiber-optic cables through a conduit underground in accordance with some embodiments of the present disclosure. FIG. 6E includes trench 675, duct 665, duct organizer 680, pull plate 650, and conduit A 605. Trench 675 resembles a piece of land that a conduit is placed in to run the telecommunications lines or cables. Once placed in trench 675, duct 665 is run through duct organizer 680, which functions to organize the fiber-optic cables so that they are organized in a pattern such as one demonstrated in FIG. 2A or 2B, for example. In various embodiments, duct organizer 680 distributes each duct 665 into a 5/10 pattern. In other embodiments, duct organizer 680 distributes each duct 665 into a 41-way pattern, or some other pattern. After organizing the individual ducts, swivel heads are placed on each duct 665 so that pull plate 650 can be attached to duct 665 before entering conduit A 605. Then, as shown in FIG. 6F, each of duct 665 is pulled simultaneously by pull plate 650 through conduit A 605. In some embodiments, pull plate 650 is attached to a winch or some other mechanical device to pull each duct 665 at the same speed and time.

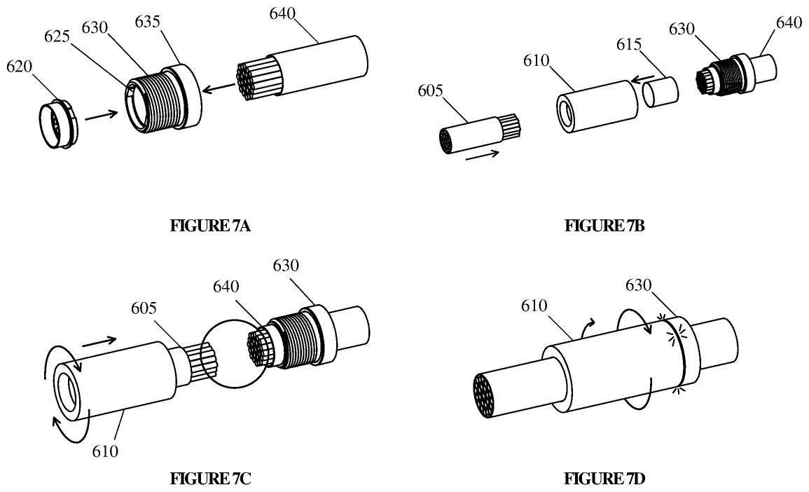

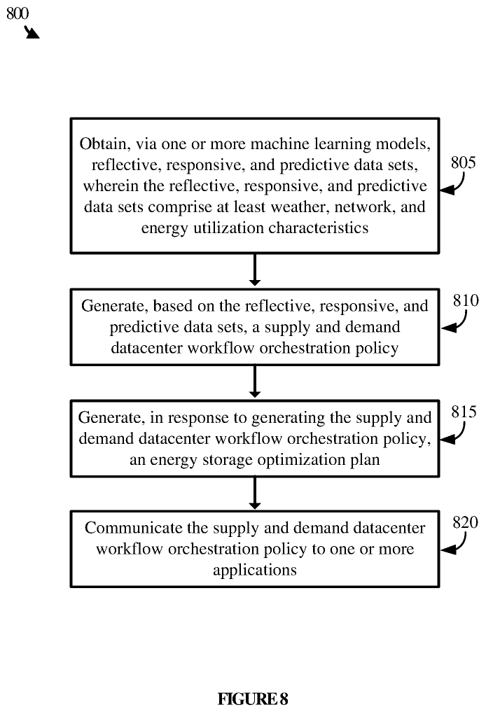

FIGS. 7A, 7B, 7C, and 7D illustrate a series of steps to use a coupling apparatus with a fiber-optic cable bundle in accordance with some embodiments of the present technology. FIGS. 7A, 7B, 7C, and 7D exemplify the coupling apparatus demonstrated in FIG. 6 that includes conduit A 605, coupling end A 610, rubber sleeve A 615, 41-way hybrid insert 620, rubber O-ring 625, coupling end B 630, rubber sleeve B 635, and conduit B 640.

As demonstrated in FIG. 7A, both 41-way hybrid insert 620 and conduit B 640 may be inserted into coupling end B 630. Coupling B 630 may comprise inserted rubber sleeve B 635 and rubber O-ring 625. Likewise, as demonstrated in FIG. 7B, conduit A 605 and rubber sleeve A 615 may be inserted into coupling end A 610. Next, in FIG. 7C, conduit A 605 and conduit B 640 may be spliced together by one or more splicing methods to create a single conduit of fiber-optic cables. Finally, in FIG. 7D, coupling end A 610 and coupling end B 630 may be connected together or inserted one into the other to form the coupling apparatus. The coupling apparatus may be twisted to lock in place or use a similar locking mechanism to prevent the bundles from coming apart and to mitigate any entry of pollutants, air, or water into the spliced area. The coupling apparatus may be used as many times as necessary along the fiber-optic cable bundles to ensure interconnection between campuses and third parties, in accordance with embodiments of the present disclosure.

FIG. 8 is a flowchart illustrating a mode of operations of an orchestration system in accordance with some embodiments of the present technology. In the set of operations illustrated in FIG. 8, data is obtained via ML modals to create an optimized cloud computing and energy storage plan. FIG. 8 includes environment 800 which further includes data collection step 808, workflow generation step 810, energy optimization step 815, and communication step 820.

Beginning with the data collection step 805, a system, computer, computing apparatus, program, processor, or the like may obtain, via one or more machine learning models, reflective, responsive, and predictive data sets, wherein the reflective, responsive, and predictive data sets comprise at least weather, network, and energy utilization characteristics. In some embodiments, further characteristics may include, but are not limited to, internet utilization, news and weather status, energy status and rates, renewable dynamics, and grid reliability.

Next, at workflow generation step 810, the system may generate, based on the reflective, responsive, and predictive data sets, a supply and demand datacenter workflow orchestration policy. As an example, the supply and demand datacenter workflow orchestration policy may inform the system or a user of the system of optimal energy sources to employ to perform one or more specific computing jobs at a specific time in order to perform efficiently and effectively. To elaborate, the ML models may inform the system that a heat wave has caused an increased use of air conditioning in various parts of the globe, which in turn has spiked energy usage. Along with increased energy usage, the ML models may also determine that a significant amount of computing jobs has occurred frequently within this same timeframe. Thus, the system may choose a different energy source and/or reroute an incoming computing job to another location for better performance.

At energy optimization step 815, the system may generate, in response to generating the supply and demand datacenter workflow orchestration policy, an energy storage optimization plan. Building upon the aforementioned example, energy sources may be used to store energy in batteries or other means in preparation for high energy costs or usage elsewhere.

Lastly, at communication step 820, the system may communicate or implement the supply and demand datacenter workflow orchestration policy downstream to one or more applications, systems, computing apparatuses, or the like. In some embodiments, the orchestration policy may be communicated over a cloud integration. In other embodiments, the orchestration policy may be implemented in a local application or computing apparatus. Communication methods may include, but are not limited to, secure file transfer protocol, application programming interface, transfer via a computer-readable storage media, or the like.

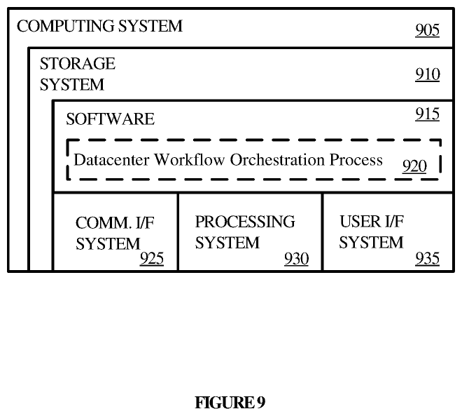

FIG. 9 illustrates computing system 905 that is representative of any system or collection of systems in which the various processes, programs, services, and scenarios disclosed herein may be implemented. This computing system may be implemented in supply and demand orchestration policy engine 515 of FIG. 5 to operate datacenter workflows and energy optimization. Examples of computing system 905 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 905 may be implemented as a single apparatus, system, or device or may be implemented in a distributed manner as multiple apparatuses, systems, or devices. Computing system 905 includes, but is not limited to, storage system 910, processing system 930, software 915, communication interface system 925, and user interface system 935. Processing system 930 is operatively coupled with storage system 910, communication interface system 925, and user interface system 935.

Processing system 930 loads and executes software 915 from storage system 910. Software 915 includes and implements datacenter workflow orchestration process 920, which is representative of the data collection and energy storage and optimization processes discussed with respect to the preceding Figures. When executed by processing system 930 to provide datacenter workflow orchestration processes, software 915 directs processing system 930 to operate as described herein for at least the various processes, operational scenarios, and sequences discussed in the foregoing implementations. Computing system 905 may optionally include additional devices, features, or functionality not discussed for purposes of brevity.

Referring still to FIG. 9, processing system 930 may include a micro-processor and other circuitry that retrieves and executes software 915 from storage system 910. Processing system 930 may be implemented within a single processing device but may also be distributed across multiple processing devices or sub-systems that cooperate in executing program instructions. Examples of processing system 930 include general purpose central processing units, graphical processing units, application specific processors, and logic devices, as well as any other type of processing device, combinations, or variations thereof.

Storage system 910 may include any computer readable storage media readable by processing system 930 and capable of storing software 915. Storage system 910 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 910 may also include computer readable communication media over which at least some of software 915 may be communicated internally or externally. Storage system 910 may be implemented as a single storage device but may also be implemented across multiple storage devices or sub-systems co-located or distributed relative to each other. Storage system 910 may incorporate additional elements, such as a controller, capable of communicating with processing system 930 or possibly other systems.

Software 915 (including datacenter workflow orchestration process 920) may be implemented in program instructions and among other functions may, when executed by processing system 930, direct processing system 930 to operate as described with respect to the various operational scenarios, sequences, and processes illustrated herein. For example, software 915 may include program instructions for implementing any multi-site and/or multi-tenant datacenter workflows and processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 915 may include additional processes, programs, or components, such as operating system software, virtualization software, or other application software. Software 915 may also include firmware or some other form of machine-readable processing instructions executable by processing system 930.

In general, software 915 may, when loaded into processing system 930 and executed, transform a suitable apparatus, system, or device (of which computing system 905 is representative) overall from a general-purpose computing system into a special-purpose computing system customized to provide datacenter orchestration processes as described herein. Indeed, encoding software 915 on storage system 910 may transform the physical structure of storage system 910. The specific transformation of the physical structure may depend on various factors in different implementations of this description. Examples of such factors may include, but are not limited to, the technology used to implement the storage media of storage system 910 and whether the computer-storage media are characterized as primary or secondary storage, as well as other factors.

For example, if the computer readable storage media are implemented as semiconductor-based memory, software 915 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 925 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 905 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a datacenter orchestration engine in a multi-tenant environment, comprising:
on a per-tenant basis:
obtaining, via one or more machine learning models, at least a real-time utilization of energy grids and an available energy supply of the energy grids for use by datacenters over a period of time;
obtaining, via the one or more machine learning models, a cloud-computing demand projected for the datacenters during the period of time;
generating a cloud-computing optimization plan based at least on the real-time utilization of the energy grids, the available energy supply, and the cloud-computing demand, wherein the cloud-computing optimization plan identifies a cloud-computing job schedule and one or more energy grids of the energy grids available to the datacenters; and
providing the cloud-computing optimization plan to one or more tenants.

2. The method of claim 1, wherein the energy grids comprise renewable energy sources and non-renewable energy sources.

3. The method of claim 1, wherein the cloud-computing schedule assigns a routing path between each cloud-computing job of a plurality of cloud-computing jobs and a datacenter of the datacenters.

4. The method of claim 1, wherein providing the cloud-computing optimization plan to the one or more tenants comprises communicating with the one or more tenants via an application programming interface.

5. The method of claim 1, wherein obtaining the cloud-computing demand projected for the datacenters comprises identifying a current amount of cloud-computing jobs assigned to the datacenters and a historical pattern of the cloud-computing jobs assigned to the datacenters.

6. The method of claim 1, further comprising obtaining a news status and a weather status corresponding to geographies around the datacenters.

7. A computing apparatus, comprising:
one or more computer-readable storage media;
a processing system operatively coupled with the one or more computer-readable storage media; and
program instructions stored on the one or more computing-readable storage media that, based on being read and executed by the processing system, direct the computing apparatus to at least:
on a per-tenant basis:
obtain, via one or more machine learning models, at least a real-time utilization of energy grids and an available energy supply of the energy grids for use by datacenters over a period of time;
obtain, via the one or more machine learning models, a cloud-computing demand projected for the datacenters during the period of time;
generate a cloud-computing optimization plan based at least on the real-time utilization of the energy grids, the available energy supply, and the cloud-computing demand, wherein the cloud-computing optimization plan comprises a cloud-computing job schedule and one or more energy grids of the energy grids available to the datacenters; and
provide the cloud-computing optimization plan to one or more tenants.

9. The computing apparatus of claim 7, wherein the energy grids comprise renewable energy sources and non-renewable energy sources.

10. The computing apparatus of claim 7, wherein the cloud-computing schedule assigns a routing path between each cloud-computing job of a plurality of cloud-computing jobs and a datacenter of the datacenters.

11. The computing apparatus of claim 7, wherein to provide the cloud-computing optimization plan to the one or more tenants, the program instructions direct the computing apparatus to communicate with the one or more tenants via an application programming interface.

12. The computing apparatus of claim 7, wherein to obtain the cloud-computing demand projected for the datacenters, the program instruction direct the computing apparatus to identify a current amount of cloud-computing jobs assigned to the datacenters and a historical pattern of the cloud-computing jobs assigned to the datacenters.

13. The computing apparatus of claim 7, wherein the program instructions further direct the computing apparatus to obtain a news status and a weather status corresponding to geographies around the datacenters.

14. One or more computer-readable storage media having program instructions stored thereon to operate an orchestration engine in an industrial automation environment, wherein the program instructions, when read and executed by a processing system, direct the processing system to at least:
obtain, via one or more machine learning models, at least a real-time utilization of energy grids and an available energy supply of the energy grids for use by datacenters over a period of time;
obtain, via the one or more machine learning models, a cloud-computing demand projected for the datacenters during the period of time;
generate a cloud-computing optimization plan based at least on the real-time utilization of the energy grids, the available energy supply, and the cloud-computing demand, wherein the cloud-computing optimization plan comprises a cloud-computing job schedule and one or more energy grids of the energy grids available to the datacenters; and
provide the cloud-computing optimization plan to one or more tenants.

16. The one or more computer-readable storage media of claim 14, wherein the energy grids comprise renewable energy sources and non-renewable energy sources.

17. The one or more computer-readable storage media of claim 14, wherein the cloud-computing schedule assigns a routing path between each cloud-computing job of a plurality cloud-computing jobs and a datacenter of the datacenters.

18. The one or more computer-readable storage media of claim 14, wherein to provide the cloud-computing optimization plan to the one or more applications, the program instructions direct the processing system to communicate with the one or more tenants via an application programming interface.

19. The one or more computer-readable storage media of claim 14, wherein to obtain the cloud-computing demand projected for the datacenters, the program instruction direct the processing system to identify a current amount of cloud-computing jobs assigned to the datacenters and a historical pattern of the cloud-computing jobs assigned to the datacenters.

20. The one or more computer-readable storage media of claim 14, wherein the program instructions further direct the processing system to obtain a news status and a weather status corresponding to geographies around the datacenters.

21. A fiber-optic bundle coupling apparatus, comprising:
a first coupling end, wherein the first coupling end encapsulates a first fiber-optic bundle of at least 100,000 fiber-optic cables inserted into a strand separator and surrounded by a first rubber sleeve;
a second coupling end, wherein the second coupling end encapsulates a second fiber-optic bundle of at least 100,000 fiber-optic cables surrounded by a second rubber sleeve; and
a locking mechanism, wherein the first fiber-optic bundle and the second fiber-optic bundle are spliced together and the first coupling end and the second coupling end are mated to cover spliced areas of the first and second fiber-optic bundles.

22. The fiber-optic bundle coupling apparatus of claim 21, wherein the locking mechanism creates a single fiber-optic bundle of at least 100,000 fiber-optic cables.

23. The fiber-optic bundle coupling apparatus of claim 22, wherein the locking mechanism creates a waterproof seal to protect the single fiber-optic bundle of at least 100,000 fiber-optic cables.

24. The fiber-optic bundle coupling apparatus of claim 21, wherein the at least 100,000 fiber-optic cables of the first fiber-optic bundle and the second fiber-optic bundle are organized in a 41-way pattern.

25. The fiber-optic bundle coupling apparatus of claim 21, wherein the at least 100,000 fiber-optic cables of the first fiber-optic bundle and the second fiber-optic bundle are organized in a 5.10 pattern.
